(19) United States
(12) Patent Application Publication
(10) Pub. No.: US 2024/0196075 A1
(43) Pub. Date: Jun. 13, 2024

(54) OPTICAL ELEMENT DRIVING DEVICE, CAMERA MODULE, AND CAMERA-MOUNTED APPARATUS

(71) Applicants: Yukihiro TAKIMOTO, Tokyo (JP); Masahiko ARANAI, Tokyo (JP)

(72) Inventors: Yukihiro TAKIMOTO, Tokyo (JP); Masahiko ARANAI, Tokyo (JP)

(73) Assignee: MITSUMI ELECTRIC CO., LTD., Tokyo (JP)

(21) Appl. No.: 18/531,963

(22) Filed: Dec. 7, 2023

(30) Foreign Application Priority Data
Dec. 13, 2022 (JP) 2022-198515

(51) Int. Cl. H04N 23/55; G02B 7/08; G02B 27/64; H04N 23/54; H04N 23/57

(52) U.S. Cl. CPC H04N 23/55; G02B 7/08; G02B 27/646; H04N 23/54; H04N 23/57; G03B 13/36; G03B 2205/0069

(57) ABSTRACT

According to an embodiment, an optical element driving device is provided with: a movable portion in which an optical element is holdable; a fixed portion which accommodates the movable portion; and a drive unit which operates the movable portion relative to the fixed portion, in which the drive unit includes a magnet arranged on the movable portion and coils arranged on the fixed portion, and the fixed portion includes a base and a bobbin to which at least one of the coils is attached and which is fixed to the base.

### INCORPORATION BY REFERENCE

This application is based upon, and claims the benefit of priority from, corresponding Japanese Patent Application No. 2022-198515 filed in the Japan Patent Office on Dec. 13, 2022, the entire contents of which are incorporated herein by reference.

### BACKGROUND OF THE INVENTION

### Technical Field

The present invention relates to an optical element driving device, a camera module, and a camera-mounted apparatus.

### Background Art

Generally, in portable terminals such as smartphones, a small camera module is mounted. To such a camera module, a lens driving device having an autofocus function (hereinafter referred to as an “AF function,” AF: Auto Focus) of automatically performing focusing when an image of a subject is captured and a shake correction function (hereinafter referred to as an “OIS function,” OIS: Optical Image Stabilization) of optically correcting a camera shake (oscillation) that occurs at the time of image capturing to reduce image blurs is applied.

The lens driving device having the AF function and the OIS function is provided with an autofocus drive unit (hereinafter referred to as an “AF drive unit”) for moving a lens portion in an optical axis direction, and a shake correction drive unit (hereinafter referred to as an “OIS drive unit”) for causing the lens portion to be swung in a plane orthogonal to the optical axis direction.

For example, JP 2022-001931 A discloses, as the OIS drive unit, a structure including a coil and a magnet for operating a movable portion provided with a reflection portion. Since the movable portion operates in two directions, a plurality of coils and magnets are provided. Each coil is mounted on a substrate provided in the vicinity of the movable portion. The substrate is configured in such a way as to be bent to surround a side surface of the movable portion in order to fix the coil at a position corresponding to the magnet which is provided on the side surface of the movable portion.

### SUMMARY OF THE INVENTION

Incidentally, since the positions of the coil and the magnet affect a driving force of the camera module, preferably, the positioning accuracy of the coil and the magnet should be improved. Therefore, considering the formation accuracy of the substrate, a structure in which the positioning accuracy of the coil is improved is desirable.

An object of the present invention is to provide an optical element driving device, a camera module, and a camera-mounted apparatus in which positioning accuracy of a coil can be improved.

An optical element driving device according to the present invention is provided with: a movable portion in which an optical element is holdable; a fixed portion which accommodates the movable portion; and a drive unit which operates the movable portion relative to the fixed portion, in which the drive unit includes a magnet arranged on the movable portion and coils arranged on the fixed portion, and the fixed portion includes a base and a bobbin to which at least one of the coils is attached and which is fixed to the base.

A camera module according to the present invention pertains to a camera module provided with: the above-described optical element driving device; a lens portion; and an imaging portion which captures a subject image formed as an image by the lens portion.

A camera-mounted apparatus according to the present invention pertains to a camera-mounted apparatus being an information device or a transportation device, and is provided with: the above-described camera module; and an image processing portion which processes image information obtained by the camera module.

According to the present invention, positioning accuracy of the coil can be improved.

### BRIEF DESCRIPTION OF THE DRAWINGS

FIG. 1A is a diagram illustrating a smartphone in which a camera module according to an embodiment of the present invention is mounted.

FIG. 1B is a diagram illustrating a smartphone in which a camera module according to an embodiment of the present invention is mounted.

FIG. 2 is a perspective view illustrating an outer appearance of a camera module.

FIG. 3 is a perspective view illustrating an outer appearance of an optical path bending module.

FIG. 4 is a cross-sectional view of the optical path bending module.

FIG. 5 is an exploded perspective view of the optical path bending module.

FIG. 6 is an exploded perspective view of a movable portion and a fixed portion.

FIG. 7 is an exploded perspective view of a movable portion and a ball guide.

FIG. 8 is an exploded perspective view of a fixed portion and a bobbin.

FIG. 9 is a diagram of a substrate and a bobbin as seen from an X direction side.

FIG. 10 is a diagram for illustrating a positional relationship between a biasing spring and a bobbin.

FIG. 11 is a diagram for illustrating a positional relationship between a biasing spring and a bobbin.

FIG. 12A is a diagram illustrating a car as a camera-mounted apparatus in which an onboard camera module is mounted.

FIG. 12B is a diagram illustrating a car as a camera-mounted apparatus in which an onboard camera module is mounted.

### DESCRIPTION OF THE EMBODIMENTS

Embodiments according to the present invention will be described below in detail with reference to the accompanying drawings. A camera module and a camera-mounted apparatus according to an embodiment which will be described later are one example of an optical element driving device, a camera module, and a camera-mounted apparatus according to the present invention, and the present invention is not limited by the embodiment. Further, the optical element driving device, the camera module, and the camera-mounted apparatus according to the present invention may be provided with all of the structures which will be described later, or may not be provided with some of the structures.

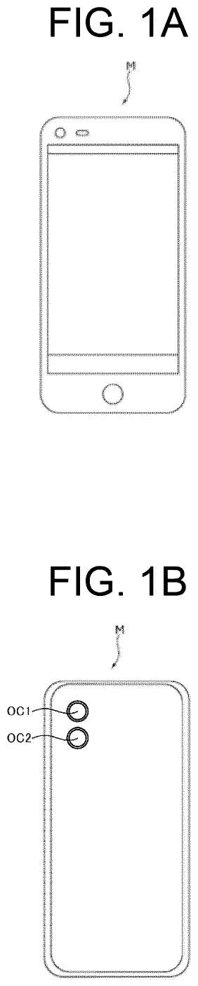

A camera module 1 is mounted in, for example, a smartphone M (see FIGS. 1A and 1B), a portable telephone, a digital camera, a notebook-sized personal computer, a tablet terminal, a handheld game console, and a thin camera-mounted apparatus (e.g., an onboard camera). The smartphone M includes a dual camera comprised of two rear cameras OC1 and OC2. In the present embodiment, the camera module 1 is applied to the rear camera OC2.

In the following, each element which constitutes the camera module 1 of the present embodiment will be described with respect to the state in which the constituent elements are incorporated into the camera module 1. Further, in describing the configuration of the camera module 1 of the present embodiment, a Cartesian coordinate system (X, Y, Z) indicated in each figure will be used.

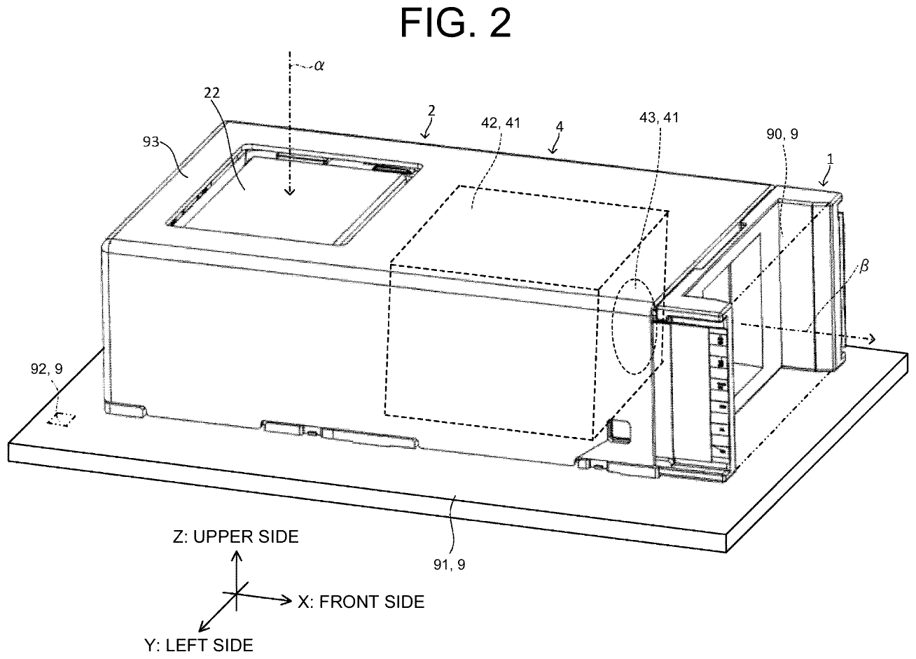

As illustrated in FIG. 2, the camera module 1 is provided with a housing 93, an optical path bending module 2, a lens module 4, and an imaging element module 9. In the housing 93, the optical path bending module 2 and the lens module 4 are accommodated, and the imaging element module 9 is attached to an end portion of the housing 93 on a positive (+) side in the X direction of the housing 93.

The camera module 1 is mounted in such a way that, when an image is to be actually captured by a camera-mounted apparatus, the X direction corresponds to a left-right direction of the camera-mounted apparatus, the Y direction corresponds to an up-down direction of the camera-mounted apparatus, and the Z direction corresponds to a front-rear direction of the camera-mounted apparatus, for example.

Light from a subject (incident light) enters a prism 22 of the optical path bending module 2 from the + side (positive side) in the Z direction of the camera module 1, as indicated by a dashed line α (also referred to as a first optical axis) in FIG. 2. The light which has entered the prism 22 (emission light) is bent by an optical path bending surface of the prism 22 (see FIG. 2) and is guided to a lens portion 41 of the lens module 4 which is arranged on the + side in the X direction, as indicated by a dashed line β(also referred to as a second optical axis) in FIG. 2. Then, a subject image formed as an image by the lens portion 41 is captured by the imaging element module 9 (see FIG. 2) which is arranged in front of the lens module 4.

In the optical path bending module 2, a structure whereby shake correction (OIS) can be performed is incorporated. In other words, the optical path bending module 2 has a camera shake correction function. Details of the optical path bending module 2 will be described later.

The lens module 4 has an autofocus function, and includes the lens portion 41 and an AF device. The lens portion 41 is arranged in an accommodation space that exists on the + side in the X direction relative to the optical path bending module 2 in the housing 93 in such a state that the lens portion 41 is held by a lens guide (not shown). The lens portion 41 includes a lens barrel 42 and one or more lenses 43 held in the lens barrel 42. The lens portion 41 is provided to be displaceable in the X direction via the lens guide.

The AF device is a drive unit, and causes the lens portion 41 to be displaced in the X direction in order to perform autofocusing. A configuration of the AF device is not limited. For example, the AF device may be one which moves the lens portion 41 in the X direction by converting a rotational movement of a motor (not shown) into a linear movement in the X direction by a conversion mechanism. By this feature, the camera module 1 performs the autofocusing.

The imaging element module 9 is arranged on the + side in the X direction relative to the lens portion 41. The imaging element module 9 is configured to include an imaging element such as a charge-coupled device (CCD) type image sensor or a complementary metal-oxide semiconductor (CMOS) type image sensor, for example. An imaging element 90 of the imaging element module 9 captures a subject image formed as an image by the lens portion 41, and outputs an electrical signal corresponding to the subject image. A sensor substrate 91 is electrically connected to the imaging element module 9, and power feeding to the imaging element module 9 and output of an electrical signal of the subject image, which has been captured by the imaging element module 9, are performed via the sensor substrate 91. As the imaging element module 9 described above, one of a conventionally known configuration can be employed.

Further, a control portion 92 is provided on the sensor substrate 91. The control portion 92 is provided with a central processing unit (CPU), a read-only memory (ROM), a random-access memory (RAM), and the like. The CPU reads a program corresponding to the processing contents from the ROM and develops the read program in the RAM, and performs centralized control of the optical path bending module 2, etc., in cooperation with the developed program.

Next, details of the optical path bending module 2 will be described.

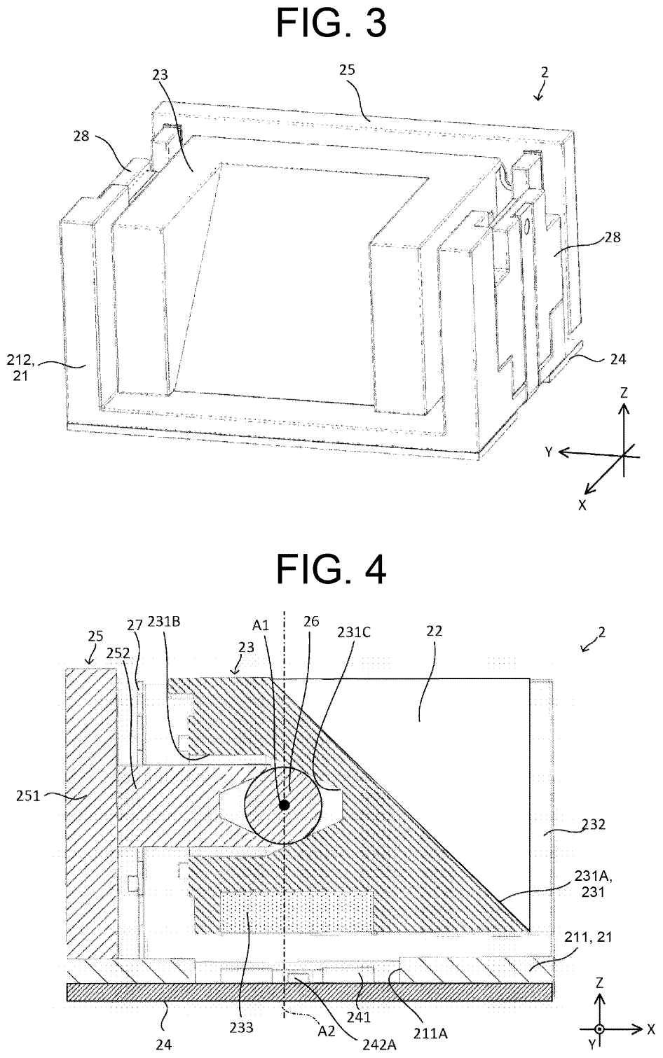

As illustrated in FIGS. 3 and 4, the optical path bending module 2 is provided with a fixed portion 21, a prism 22, a movable portion 23, a substrate 24, a ball guide 25, a ball 26, a biasing spring 27, and a bobbin 28. The optical path bending module 2 corresponds to the “optical element driving device” of the invention.

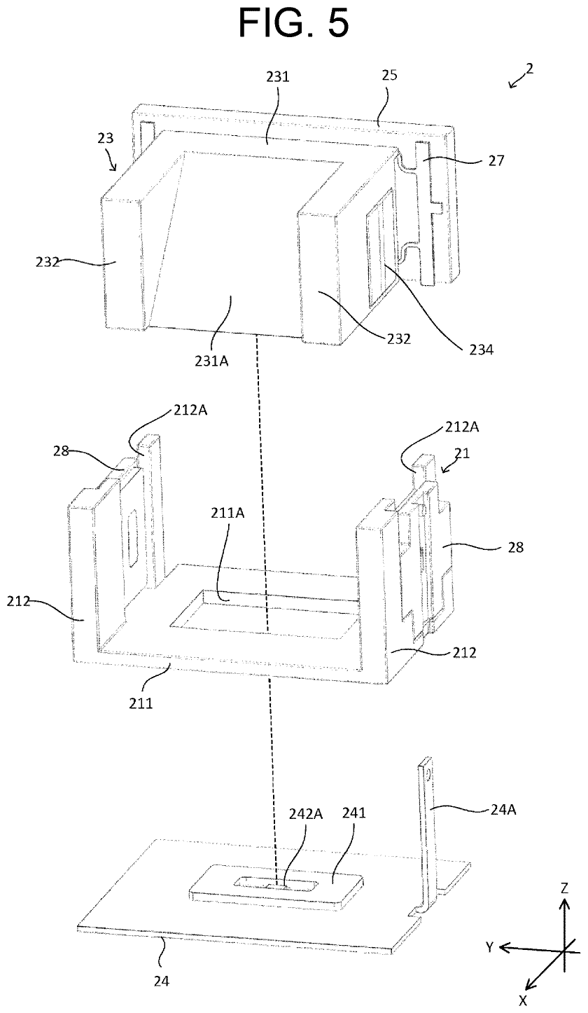

As illustrated in FIG. 5, the fixed portion 21 is configured in such a way that the fixed portion 21 can accommodate the prism 22 and the movable portion 23, and is fixed inside the housing 93. The fixed portion 21 includes a bottom wall portion 211 and a pair of sidewall portions 212. The bottom wall portion 211 and the pair of sidewall portions 212 correspond to a “base” of the present invention.

The bottom wall portion 211 is a bottom wall part of the fixed portion 21. A rectangular-shaped through hole 211A is formed at a central part of the bottom wall portion 211. At a position corresponding to the through hole 211A on a negative (−) side in the Z direction of the bottom wall portion 211, a first coil 241 of the substrate 24, which will be described later, is arranged. Also, at a position corresponding to the through hole 211A on a positive (+) side in the Z direction of the bottom wall portion 211, a first magnet 233 of the movable portion 23 is arranged.

The sidewall portions 212 forming a pair are provided on both end portions of the bottom wall portion 211 in the Y direction, and are opposed to side surfaces of the movable portion 23 on both sides in the Y direction. A cutout is formed at a substantially central part of each of the sidewall portions 212, and the cutout portion serves as an arrangement portion 212A for arranging the bobbin 28.

As illustrated in FIG. 4, the movable portion 23 swings the prism 22 about a first axis A1 parallel to the Y direction and a second axis A2 parallel to the Z direction, thereby performing shake correction in a direction of rotation around the first axis A1, and shake correction in a direction of rotation around the second axis A2. The movable portion (a shake correction device) 23 as described above is arranged in an accommodation space surrounded by the bottom wall portion 211 and the pair of sidewall portions 212 of the fixed portion 21, and a wall portion 251 of the ball guide 25.

The movable portion 23 is a holder that swingably supports the prism 22 relative to the fixed portion 21, and is configured to be swingable about the first axis A1 and also swingable about the second axis A2.

As illustrated in FIGS. 4 and 5, the movable portion 23 is made of synthetic resin, and includes a support wall portion 231 and a pair of sidewall portions 232. Also, on the movable portion 23, the first magnet 233 and a second magnet 234 to drive the movable portion 23 are provided.

The support wall portion 231 is a wall portion on which the prism 22 is mounted, and is opposed to the bottom wall portion 211 of the fixed portion 21 on the—side in the Z direction and is opposed to the wall portion 251 of the ball guide 25 on a negative (−) side in the X direction.

A surface of the support wall portion 231 on the + side in the X direction is a mounting surface 231A for mounting the prism 22 thereon, and is inclined in such a way that the surface of the support wall portion 231 is located more on the—side in the Z direction as it draws toward the + side in the X direction.

A central part on a surface of the support wall portion 231 at the—side in the X direction (i.e., the part corresponding to a support portion 252 of the ball guide 25) is provided with a recess 231B. The recess 231B has a cylindrical shape having a length which allows the support portion 252 to enter in the recess 231B. A distal end part of the recess 231B is configured in a substantially conical shape, and serves as a ball arrangement portion 231C where the ball 26 is to be arranged.

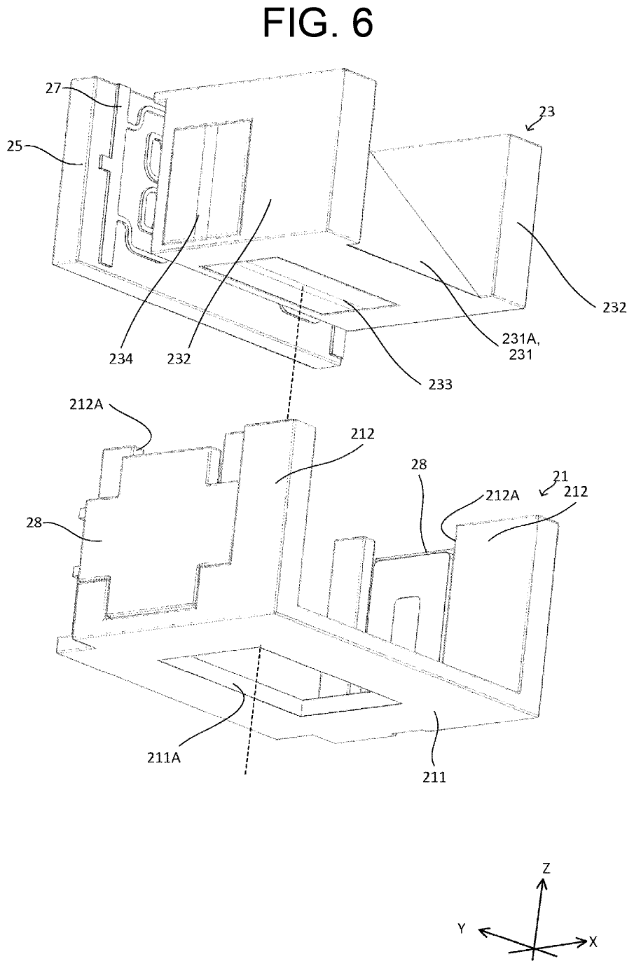

Also, on a surface of the support wall portion 231 on the—side in the Z direction, a recess which is recessed to allow the first magnet 233 to be arranged therein is formed. The recess is provided at a position corresponding to the through hole 211A in the bottom wall portion 211 of the fixed portion 21 described above, and the first magnet 233 is arranged inside the recess (see also FIG. 6).

The sidewall portions 232 forming a pair are provided on both end portions of the movable portion 23 in the Y direction and sandwich the mounting surface 231A of the movable portion 23 in the Y direction. The prism 22 is arranged in a space surrounded by the pair of sidewall portions 232 and the mounting surface 231A.

Also, on a surface of each of the sidewall portions 232, which is on a side opposite to the mounting surface 231A, a recess which is recessed to allow the second magnet 234 to be arranged therein is formed. The recess is provided at a position corresponding to the arrangement portion 212A at each of the sidewall portions 212 of the fixed portion 21 described above, and the second magnet 234 is arranged inside the recess (see also FIG. 6).

The substrate 24 is configured from a flexible substrate, and is arranged at a position opposed to the bottom wall portion 211 of the fixed portion 21 on the—side in the Z direction. Also, at a central part of an end portion of the substrate 24 on a negative (−) side in the Y direction, an arrangement portion 24A for arranging a second Hall element, which will be described later, is provided. The arrangement portion 24A extends from the end portion of the substrate 24 on the—side in the Y direction toward the + side in the Z direction, and is formed by bending the substrate 24.

The first coil 241 is arranged at a position, in the substrate 24, corresponding to the through hole 211A of the bottom wall portion 211. Further, the movable portion 23 is arranged on a side, which is opposite to the substrate 24, of the bottom wall portion 211, and the first magnet 233 is arranged at a position corresponding to the through hole 211A, as described above.

The first magnet 233 and the first coil 241 constitute a first drive unit, which is a voice coil motor. The first drive unit drives the movable portion 23 such that the movable portion 23 is swung about the first axis A1. The first axis A1 is an axis parallel to the Y direction.

Also, a first Hall element 242A is arranged at a position corresponding to the first coil 241 on the substrate 24. The position of the movable portion 23, which is driven by the first drive unit, is detected by the first Hall element 242A.

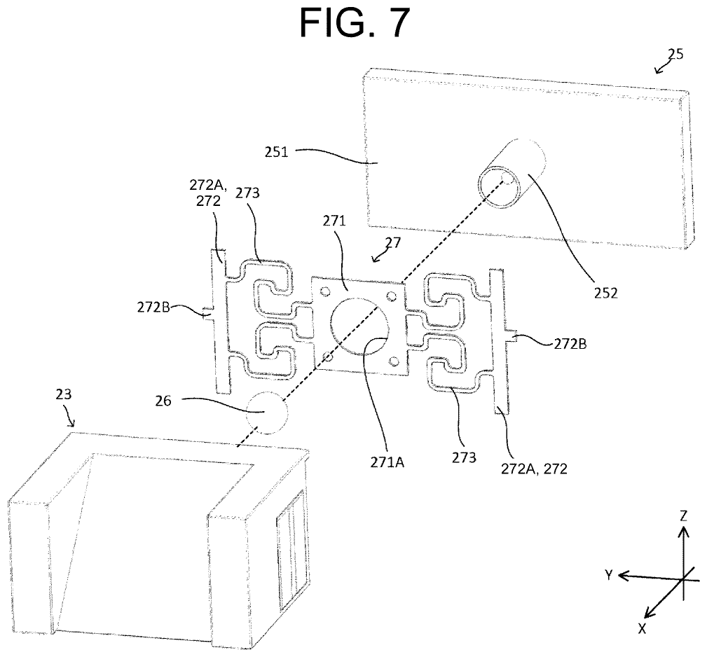

As illustrated in FIGS. 4 and 7, the ball guide 25 is a part that guides and supports the ball 26 for swinging the movable portion 23, and is fixed at a position corresponding to an end portion of the fixed portion 21 on the—side in the X direction. The ball guide 25 includes the wall portion 251 and the support portion 252.

The wall portion 251 constitutes a side wall which is opposed to a side surface of the movable portion 23 on the—side in the X direction. The support portion 252 is provided to protrude from a central part of the wall portion 251 toward the + side in the X direction. A distal end part of the support portion 252 is a part that supports the ball 26.

The support portion 252 is arranged at a position of entering inside the recess 231B of the movable portion 23 described above. Further, the ball 26 at the distal end part of the support portion 252 is arranged to be in contact with a wall surface of the ball arrangement portion 231C inside the recess 231B.

Consequently, the movable portion 23 is enabled to swing about a part corresponding to the ball 26, in other words, about the first axis A1 and the second axis A2.

The biasing spring 27 is a plate spring configured from a member having conductivity. The biasing spring 27 is arranged between the support wall portion 231 of the movable portion 23 and the wall portion 251 of the ball guide 25 such that the movable portion 23 can be biased toward the rear (i.e., the—side in the X direction).

The biasing spring 27 includes a central portion 271, a contact portion 272, and a connection portion 273. The central portion 271 is a part that is arranged at a central part of the biasing spring 27 in the Y direction, and is arranged at a position corresponding to the movable portion 23. In the central portion 271, a hole 271A through which the support portion 252 of the ball guide 25 passes is formed.

The contact portion 272 is a part that is in contact with a tying portion 28A of the bobbin 28, which will be described later, and is provided on each of the two sides of the central portion 271 in the Y direction. Specifically, the contact portion 272 includes a main body part 272A extending in the Z direction, and a protruding part 272B protruding from the main body part 272A to a side opposite to the central portion 271.

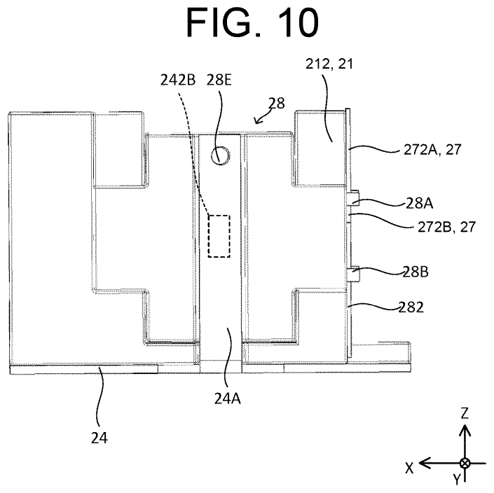

The main body part 272A is arranged at a position corresponding to each of the sidewall portions 212 of the fixed portion 21, and is fixed to each of the sidewall portions 212. The protruding part 272B is arranged at a position corresponding to the tying portion 28A of the bobbin 28, and is in contact with the tying portion 28A (see FIG. 10).

The connection portion 273 is a part that connects between the central portion 271 and each of the contact portions 272, and generates a force that biases the movable portion 23 to the rear. Consequently, the ball 26 is held between the ball arrangement portion 231C and the support portion 252 inside the recess 231B.

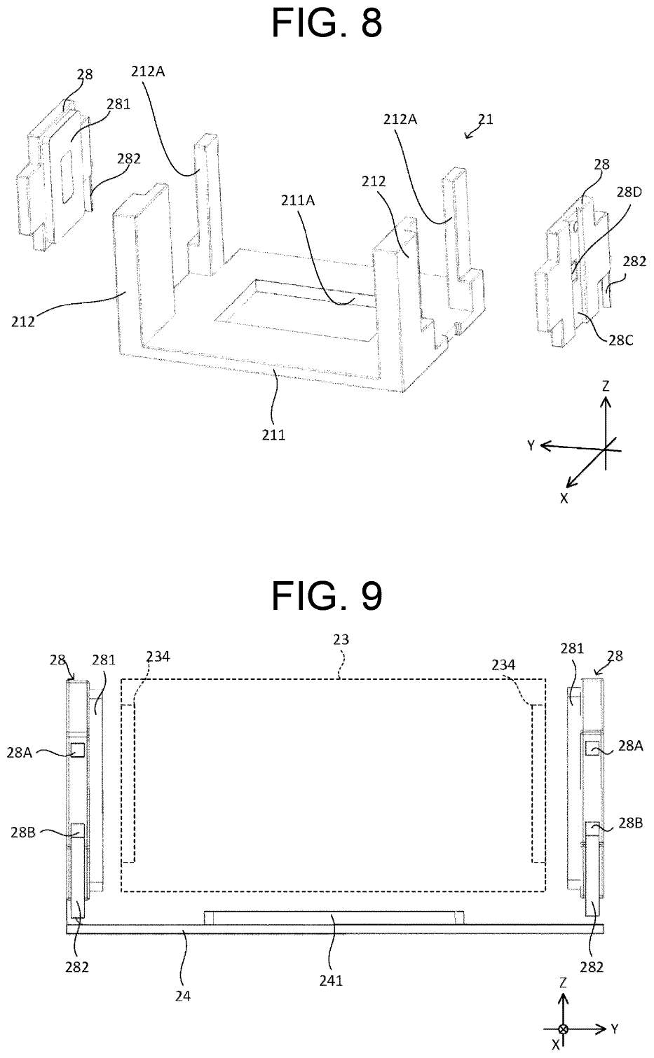

As illustrated in FIGS. 8 and 9, the bobbin 28 is a plate-like member made of synthetic resin, for example, and includes a part around which a second coil 281 is wound. The bobbin 28 is arranged in the arrangement portion 212A of the sidewall portion 212 of the fixed portion 21 such that the second coil 281 is arranged to be located on the movable portion 23 side. Further, the second magnet 234 is arranged at a position opposed to the arrangement portion 212A of the sidewall portion 212.

The second magnet 234 and the second coil 281 constitute a second drive unit, which is a voice coil motor. The second drive unit drives the movable portion 23 such that the movable portion 23 is swung about the second axis A2. The second axis A2 is an axis parallel to the Z direction.

At an end portion of the bobbin 28 on the—side in the X direction, two tying portions, i.e., the tying portions 28A and 28B, are provided side by side in the Z direction. As illustrated in FIG. 10, the tying portions 28A and 28B protrude from the end portion of the bobbin 28. One end and the other end of the second coil 281 are connected to the tying portions 28A and 28B, respectively.

The tying portion 28B is positioned on the—side in the Z direction relative to the tying portion 28A, and an electrode terminal 282 is inserted at a position corresponding to the tying portion 28B of the bobbin 28. The electrode terminal 282 extends from the tying portion 28B toward the—side in the Z direction and is connected to the substrate 24. By this feature, power is to be fed from the substrate 24 to the second coil 281 via the electrode terminal 282 and the tying portion 28B.

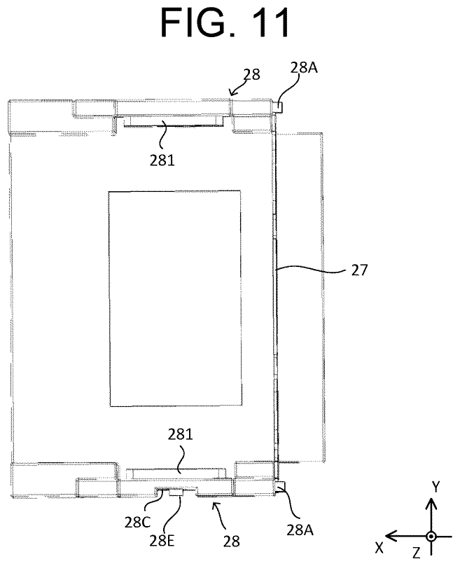

Further, the contact portion 272 (the protruding part 272B) of the biasing spring 27 described above is in contact with the tying portion 28A of the bobbin 28. As the contact portion 272 is brought into contact with the tying portion 28A, the contact portion 272 and the second coil 281 are connected to each other via the tying portion 28A, as illustrated in FIG. 11. In other words, as the biasing spring 27 is provided over a range from one side surface portion to the other side surface portion at an end portion of the fixed portion 21, the second coils 281 of the bobbins 28 that are respectively arranged at the sidewall portions 212 are electrically connected.

Consequently, the electrode terminal 282 and the tying portions 28A and 28B of the bobbin 28 and the biasing spring 27 constitute a power feeding path of the second coil 281.

Further, as illustrated in FIG. 8, on the bobbin 28 at the—side in the Y direction, a first recess 28C for arranging the arrangement portion 24A of the substrate 24 described above is formed. On the arrangement portion 24A, a second Hall element 242B (FIG. 10) which detects the position of the movable portion 23 driven by the second drive unit is provided. At a position corresponding to the second Hall element 242B of the bobbin 28, a second recess 28D for the second Hall element 242B to enter is formed.

Moreover, as illustrated in FIGS. 10 and 11, a protruding part 28E may be provided in the first recess 28C for arranging the arrangement portion 24A in the bobbin 28. By providing a hole at a position corresponding to the protruding part 28E in the arrangement portion 24A, the protruding part 28E can be a positioning portion for the arrangement portion 24A.

According to the present embodiment configured as described above, since the bobbin 28 to which the second coil 281 is attached is provided on the sidewall portion 212 of the fixed portion 21, a positional relationship between the second coil 281 and the second magnet 234 provided on the movable portion 23 can be stabilized.

For example, in the case of a structure in which a substrate is bent to surround a side surface of a movable portion in order to make the substrate opposed to a magnet on the side surface of the movable portion and a coil is arranged at the bent part, it becomes difficult to enhance the positioning accuracy of the magnet and the coil since the formation accuracy of the substrate is not relatively high. Moreover, in the case of the structure in which the substrate is bent, the positional relationship between the magnet and the coil may be shifted due to the effect that the bent part of the substrate is flexibly deformed or the like. Also, in the case of the structure in which the substrate is bent, a member to which the coil is attached must be fixed to the substrate by soldering. For this reason, the position of the aforementioned member may be deviated. Due to these factors, it is not easy to enhance the positioning accuracy of the coil.

In contrast, in the present embodiment, the bobbin 28 having the second coil 281 attached thereon is fixed to the fixed portion 21 that is fixed to the housing 93 of the camera module 1. Therefore, a problem such as that arises by the structure in which the substrate is bent is not caused. As a result, since the positional relationship between the second magnet 234 and the second coil 281 can be stabilized, the positioning accuracy of the coil can be improved.

Also, while the second coil 281 is arranged on the bobbin 28 side, the first coil 241 is arranged on the substrate 24 side. If the first coil 241 is also arranged on the bobbin, it becomes necessary to secure a power feeding path from the outside for the first coil 241, and the structure may be complicated.

In contrast, in the present embodiment, the first coil 241 is arranged on the substrate 24, which is a common structure as an electrical connection point for connection to the outside. This arrangement eliminates the need for separately securing a power feeding path, and can also facilitate the power feeding from the substrate 24 to the second coil 281 on the bobbin 28 side via a simple mechanism. As a result, the configuration can be simplified as a whole.

Also, the substrate 24 is fixed to the bottom wall portion 211 of the fixed portion 21, and the first coil 241 is arranged at this part. In other words, since the first coil 241 is arranged on a flat plate part of the substrate 24, the effect of flexure is extremely small, and moreover, the degree of a shift of the positional relationship between the magnet and the coil is extremely small, as compared to the structure in which the coil is provided at a bending part of the substrate. That is, since the positional relationship between the first magnet 233 and the first coil 241 can be stabilized, the positioning accuracy of the coil can be improved.

Further, the second coils 281 of the bobbins 28 respectively provided on the pair of sidewall portions 212 of the fixed portion 21 are connected by means of the biasing spring (a power feeding member) 27 extending from one sidewall portion 212 toward the other sidewall portion 212. As a result, since the power feeding path can be commonalized for the two bobbins 28, the power feeding path can be simplified. In addition, the biasing spring 27 is a biasing member for biasing the movable portion 23, and since this biasing member can be used as both the biasing member and the power feeding member, the configuration can be simplified as a whole.

Further, on the bobbin 28, the electrode terminal 282 extending from the tying portion 28B toward the substrate 24 is provided. Therefore, the power feeding path from the substrate 24 to the second coil 281 can be simplified.

In the embodiment described above, the bobbin 28 is provided separately from the fixed portion 21 as a different unit. However, the present invention is not limited to the above, and the bobbin may be formed integrally with the fixed portion. In this case, since the coil needs to be wound around a bobbin part, the outer side part of the fixed portion may be made to correspond to the bobbin part.

Further, in the embodiment described above, the first coil 241 is arranged on the substrate 24. However, the present invention is not limited to the above, and the first coil may be arranged on a bobbin provided on the bottom wall portion of the fixed portion. Also, in this case, it is necessary to insert a mechanism related to power feeding from the outside into the bottom wall portion, the bobbin, etc.

Furthermore, in the embodiment described above, the biasing spring 27 is employed as the power feeding path for the two second coils 281. However, the present invention is not limited to the above, and the two second coils may each have a separate power feeding path.

Further, in the embodiment described above, the optical element driving device which drives a prism as the optical element has been described. However, the optical element to be driven may be an optical element other than the prism, such as a mirror or a lens.

Furthermore, for example, in the embodiment described above, a smartphone, which is a camera-equipped portable terminal, has been described as an example of the camera-mounted apparatus which is provided with the camera module 1. However, the present invention can be applied to a camera-mounted apparatus including a camera module and an image processing portion which processes image information obtained by the camera module. The camera-mounted apparatus includes an information device and a transportation device. The information device includes, for example, a camera-equipped portable telephone, a notebook-sized personal computer, a tablet terminal, a handheld game console, a web camera, a drone, and a camera-equipped vehicle onboard unit (e.g., a back monitor device, a drive recorder device, etc.) Further, the transportation device includes, for example, a car and a drone.

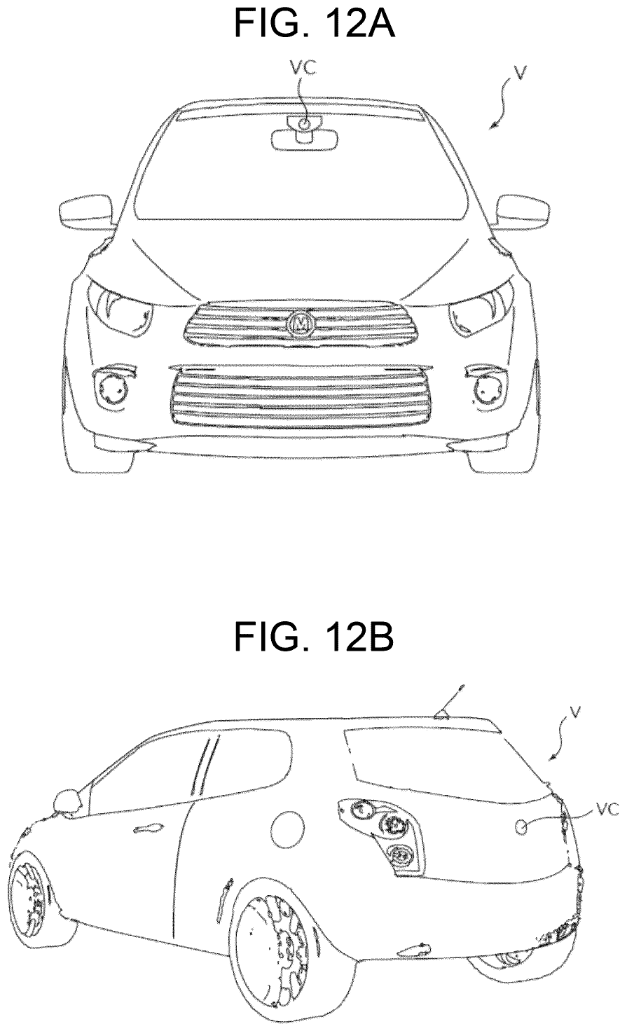

FIGS. 12A and 12B are diagrams illustrating a car V as the camera-mounted apparatus in which an onboard camera module VC (Vehicle Camera) is mounted. FIG. 12A is a front view of the car V and FIG. 12B is a rear perspective view of the car V. In the car V, the camera module 1 described in the embodiment is mounted as the onboard camera module VC. As illustrated in FIGS. 12A and 12B, the onboard camera module VC may be attached to a windshield to face the front, for example, or may be attached to a rear gate to face the rear. The onboard camera module VC is used for purposes such as for a back monitor, for a drive recorder, for collision avoidance control, for automated driving control, and so on.

The embodiment as disclosed herein is merely exemplary in all respects and should be considered as an example that is non-restrictive. The scope of the present invention is defined not by the above description but by the recitations of the claims, and it is intended that all changes that come within the meaning and scope of the claims and their equivalents are embraced herein.

What is claimed is:

1. An optical element driving device comprising:
a movable portion in which an optical element is holdable;
a fixed portion which accommodates the movable portion; and
a drive unit which operates the movable portion relative to the fixed portion, wherein
the drive unit includes a magnet arranged on the movable portion and coils arranged on the fixed portion, and
the fixed portion includes a base and a bobbin to which at least one of the coils is attached and which is fixed to the base.

2. The optical element driving device according to claim 1, further comprising a substrate which is fixed to the base, wherein
the coils include a first coil arranged on the substrate and a second coil attached to the bobbin.

3. The optical element driving device according to claim 2, wherein:
the base includes at least one sidewall portion and a bottom wall portion connected to the sidewall portion;
the bobbin is fixed to the sidewall portion; and
the substrate is fixed to the bottom wall portion.

4. The optical element driving device according to claim 2, wherein:
the base includes a pair of sidewall portions opposed to each other;
bobbins, which include the bobbin, are provided on the pair of sidewall portions, respectively; and
the second coils respectively provided on the bobbins are connected by a power feeding member extending from one sidewall portion of the pair of sidewall portions to the other sidewall portion of the pair of sidewall portions.

5. The optical element driving device according to claim 4, wherein:
the bobbin is provided with an electrode terminal for connecting the second coil; and
the electrode terminal is structured in such a way as to extend from the bobbin toward the substrate.

6. The optical element driving device according to claim 4, further comprising a biasing portion which is provided over a range from the one sidewall portion to the other sidewall portion at an end portion of the base, and biases the movable portion, wherein
the biasing portion includes the power feeding member.

7. A camera module comprising:
the optical element driving device according to claim 1;
a lens portion; and
an imaging portion which captures a subject image formed as an image by the lens portion.

8. A camera-mounted apparatus being an information device or a transportation device, the camera-mounted apparatus comprising:
the camera module according to claim 7; and
an image processing portion which processes image information obtained by the camera module.
